(19) United States
(12) Patent Application Publication
(10) Pub. No.: US 2011/0184782 A1
(43) Pub. Date: Jul. 28, 2011

(54) METHODS AND A SYSTEM FOR IMPLEMENTING BUSINESS PROCESS MANAGEMENT FOR LONG-TERM EXECUTION PROCESSES

(75) Inventors: Hubert Delany, New Rochelle, NY (US); John A. Johnson, Belle Harbor, NY (US)

(73) Assignee: CALM Energy, Inc., Belle Harbor, NY (US)

(21) Appl. No.: 13/015,499

(22) Filed: Jan. 27, 2011

Related U.S. Application Data
(60) Provisional application No. 61/298,884, filed on Jan. 27, 2010.
(60) Provisional application No. 61/298,878, filed on Jan. 27, 2010.
(60) Provisional application No. 61/298,880, filed on Jan. 27, 2010.

(51) Int. Cl. G06Q 10/00

(52) U.S. Cl. 705/7.37

(57) ABSTRACT

In one embodiment, a method for executing long-term business process includes steps of: a) providing an interface to design or modify a BPM diagram for at least one business process; b) providing at least one data structure to store specification and/or requirements of the BPM diagram and state of at least one BPM case/instance; c) receiving an incremental change to the BPM diagram; d) implementing based on a first set of rules, the incremental change into the BPM diagram; and e) translating the state of the BPM case/instance from a first condition to a second condition based on: i) the BPM diagram incorporating the implemented at least one incremental change; and ii) a second set of rules.

### RELATED APPLICATIONS

This application claims the benefit of U.S. provisional application Ser. No. 61/298,884 filed Jan. 27, 2010, entitled “METHODS AND A SYSTEM FOR BUSINESS PROCESS MANAGEMENT OF PROCESSES DESIGNED FOR LONG-TERM EXECUTION”; U.S. Provisional Application No. 61/298,878, entitled “METHODS AND A SYSTEM FOR BUSINESS PROCESS MANAGEMENT DIAGRAMS AS DATA”; U.S. Provisional Application No. 61/298,880, entitled “METHODS AND A SYSTEM FOR USE OF DIRECTORIES FOR BUSINESS PROCESS MANAGEMENT INSTANCE CORRELATION”; which are hereby incorporated by reference herein in their entirety for all purposes.

### TECHNICAL FIELD

The present invention relates to long-term business processes. For purposes of this disclosure, “a long-term business process” means “a business process that have a duration of an execution which exceeds an average rate of occurrence of changes in the business process.”

### BACKGROUND

In one embodiment, the instant invention is related to technical approach to manage business process management/modeling systems that perform business processes whose duration can be measured in months or even years, during which changes may occur in the underlying process.

### SUMMARY OF INVENTION

In some embodiments, the instant invention involves a method for executing long-term business process that can includes steps of a) providing, by a computer system, an interface to design or modify at least one BPM diagram for at least one business process; b) providing, by a computer system, at least one data structure, wherein the at least one data structure store at least one of: i) at least one specification parameter of the at least one BPM diagram, ii) at least one first requirement associated with at least one specification parameter of the at least one BPM diagram; and iii) at least one state parameter of at least one BPM instance, wherein each BPM instance represents at least one pending instance of the at least one business process which is being executed in accordance with the at least one BPM diagram; c) receiving, by a computer system, at least one incremental change to the at least one BPM diagram; d) implementing, by a computer system, based on at least one first set of rules, the at least one incremental change into the at least one BPM diagram, wherein the at least one first set of rules is applied to the at least one incremental change based on one of: i) whether the at least one incremental change requires outside information prior to be implemented; and ii) whether the at least one incremental change results in a satisfaction of the at least one requirement; and e) translating the at least one state parameter of the at least one BPM instance from a first condition to a second condition based on: i) the at least one BPM diagram incorporating the implemented at least one incremental change; and ii) at least one second set of rules, wherein applying the at least one second set of rules can result in receiving outside information which is required prior to the translating.

In some embodiments, the instant invention involves a computer system for executing long-term business process that includes a) memory having at least one region for storing computer executable program code; and b) a processor for executing the program code stored in the memory, wherein the program code which includes: i) code to provide an interface to design or modify at least one BPM diagram for at least one business process; ii) code to provide at least one data structure, wherein the at least one data structure store at least one of: 1) at least one specification parameter of the at least one BPM diagram, 2) at least one first requirement associated with at least one specification parameter of the at least one BPM diagram; and 3) at least one state parameter of at least one BPM instance, wherein each BPM instance represents at least one pending instance of the at least one business process which is being executed in accordance with the at least one BPM diagram; iii) code to receive at least one incremental change to the at least one BPM diagram; iv) code to implement, based on at least one first set of rules, the at least one incremental change into the at least one BPM diagram, wherein the at least one first set of rules is applied to the at least one incremental change based on one of: 1) whether the at least one incremental change requires outside information prior to be implemented; and 2) whether the at least one incremental change results in a satisfaction of the at least one requirement; and v) code to translate the at least one state parameter of the at least one BPM instance from a first condition to a second condition based on: 1) the at least one BPM diagram incorporating the implemented at least one incremental change; and 2) at least one second set of rules, wherein applying the at least one second set of rules can result in receiving outside information which is required prior to the translating.

### BRIEF DESCRIPTION OF THE DRAWINGS

FIG. 1 shows a schematic diagram of an embodiment of the present invention.

FIG. 2 shows a schematic diagram of another embodiment of the present invention.

FIG. 3 shows a schematic diagram of yet another embodiment of the present invention.

FIGS. 4A-B show schematic diagram of yet another embodiment of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

“A business process” means a single and/or series or network of value-added activities, performed by their relevant roles or collaborators, to purposefully achieve the common business goal.

“Business Process Management/Modeling” (“BPM”) means enterprise processes, including methods and systems, that promote and optimize business processes to achieve certain business objective (e.g., efficiency, effectiveness, flexibility, integration, etc.) For example, BPM can be a set of services and tools that provide for explicit BPM (e.g., process analysis, definition, execution, monitoring and administration), including support for human and application-level interaction. In another example, BPM supports design, execution and optimization of cross-functional business activities by both internal and external business users and technologists to incorporate people, application systems, and business partners. In yet another example, BPM can be composed of a sequence of activities (work tasks), interactions with human resources (users), or IT resources (software applications and data bases), as well as rules controlling the progression of processes through the various stages associated with its activities.

In some embodiments, BPM processes/applications can be designed for processing financial transactions. In some embodiments, BPM processes/applications can be designed for processing a credit application in which credit events (e.g., a change in credit rating, application for a credit card, or a default on a payment for example) would be monitored by a BPM server programmed by a business process diagram, and a BPM server would be used to determine how the business process would operate.

In some embodiments, BPM processes/applications can be designed for providing communication to a set of users as, for example, in a case where a set of secured mobile devices are being used by field personnel, and are managed by a centralized server. Broadcasting a message to such a set of users would require registering and scheduling a message with the centralized server. In some embodiments, mobile devices could be electronic devices such as thermostats which are capable of accepting commands or re-programming operations remotely.

In some embodiments, BPM processes/applications can be designed for any business process that uses technology to perform at least one task.

A BPM execution engine (workflow engine) is a software that is in charge of performing BPM processes.

A BPM Diagram means the entire specification of a BPM process, which includes but not limited to a BPM visual diagram. The BPM Diagram can include all associated metadata describing code to be executed for each activity of a business process which the BPM Diagram represents. For example, for activities that involve performing actions, the associated metadata can include, but not limited to, at least one of the following:

a) conditional expressions and/or statements associated with each branch operation,

b) delays and type of delay for each timer activity,

c) names of messages on message links,

d) names of variables and their format,

e) default values,

f) comments, and

g) any other metadata.

In some embodiments, to design and execute BPM diagrams, the instant invention can utilize The Object Management Group's (“OMG”) the Unified Modeling Language (“UML”) compliant Business Process Model Notation (“BPMN”) standard, which represents a standard UML 2.0 requirements diagram. The disclosure, entitled “OMG Unified Modeling Language™ (OMG UML), Version 2.2” has been incorporated herein in its entirety by reference for all purposes, specifically to illustrate the notations and applications related UML. (Appendix A.) Appendix A is included for illustrative purpose to illustrate the incorporated disclosure, and the entire incorporated disclosure is not limited to its portion in Appendix A.

In some embodiments, for purposes of this disclosure, a modeling, or case, or use case BPM diagram is a computer code and/or associated design data that represents a process/system in terms of actors, their goals (can be represented as use cases), and any dependencies between those use cases. In some embodiments, the modeling, or case, or use case BPM diagram may have a graphical overview of the computer code and/or associated design data, for example, expressed in the UML format. For example, suitable modeling, or case, or use case BPM diagrams implementations include, but are not limited to, UML diagrams, computer-aided software engineering (CASE) diagrams, UML CASE diagrams, ER diagrams, Data flow diagram, Structure charts, Decision Trees, Decision tables, etc.

In some embodiments, for purposes of this disclosure, design data can include any process data (i.e., any data associated with a process-at-issue) associated with the process-at-issue for which the modeling, or case, or use case BPM diagram is to be designed. In some embodiments, the design data is continuously updated as new information about the designed process becomes available and/or pertinent. In some embodiments, updates to the design data can result in an evolution of the modeling, or case, or use case BPM diagram based on the modeling, or case, or use case BPM diagram's specifications and/or requirement. For example, suitable design data include, but are not limited to, actors involved, tasks, duration, requirements, rules (e.g., relationships between actors and/or tasks), etc.

In some embodiments, for purposes of this disclosure, a trigger condition means a condition/event whose occurrence (or non-occurrence) results in a performance of an activity in accordance with the modeling, or case, or use case BPM diagram for a process-in-question. For example, a particular condition of an air conditioning unit (e.g., loss of power, break down, overheating, etc.) can serve as a trigger condition based on specification(s) and requirement(s) of the modeling, or case, or use case BPM diagram for a process-at-issue.

In some embodiments, for purposes of this disclosure, a normal condition means a condition/event whose occurrence (or non-occurrence) has been predicted and/or expected and thus is accounted for in the modeling, or case, or use case BPM diagram for a process-at-issue.

In some embodiments, for purposes of this disclosure, an abnormal condition or means a condition/event whose occurrence (or non-occurrence) has not been predicted and/or expected and thus is not accounted for in the modeling, or case, or use case BPM diagram for a process-at-issue.

A “state” or “program state” is a particular set of instructions which will be executed in response to the machine's input and/or essentially a snapshot of the measure of various of a system at a particular time point. For example, suitable state conditions/parameters include, but are not limited to, values, execution steps, relationships/associations, past actions, future actions, rules, etc.

### Illustrative Operating Environment

The invention may also be considered as a method of business process management including providing a network of computers and a business process control program so that a plurality of participants in a business process can interact with one another concerning the business process over the network, establishing a business process on the network made up of a plurality of tasks to be performed by the participants according to rules defined for the process, and providing a business process owner with means on the network to alter or add rules for processes that the business process owner owns.

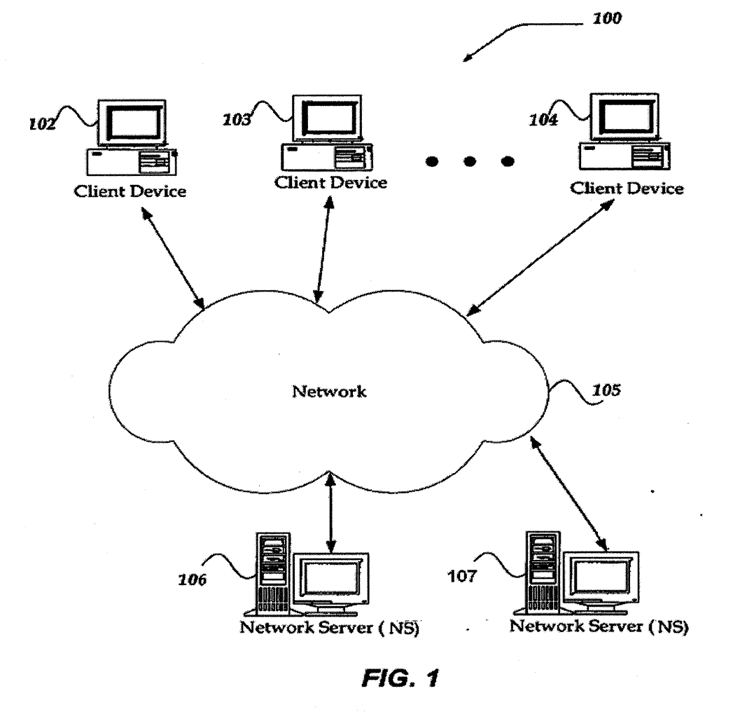

FIG. 1 illustrates one embodiment of an environment in which the present invention may operate. However, not all of these components may be required to practice the invention, and variations in the arrangement and type of the components may be made without departing from the spirit or scope of the invention. In some embodiment, the BPM inventive system hosts a large number of members and concurrent transactions. In other embodiments, the BPM inventive system computer is based on a scalable computer and network architecture that incorporates varies strategies for assessing the data, caching, searching, and database connection pooling.

In embodiments, members of the inventive computer system 102-104 (e.g. users of BPM diagram) include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser application that is configured to receive and to send web pages, and the like. In embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In embodiments, the invention is programmed in either Java or .Net.

In embodiments, member devices 102-104 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In embodiments, network 105 may be configured to couple one computing device to another computing device to enable them to communicate. In embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

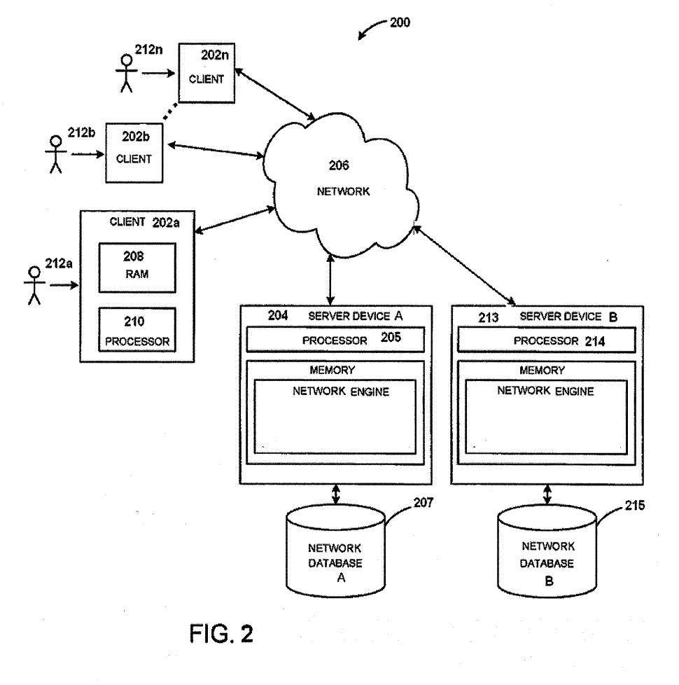

FIG. 2 shows another exemplary embodiment of the computer and network architecture that supports the inventive BPM system. The member devices 202a, 202b thru 202n shown (e.g. traders' desktops) each comprises a computer-readable medium, such as a random access memory (RAM) 208 coupled to a processor 210 or FLASH memory. The processor 210 may execute computer-executable program instructions stored in memory 208. Such processors comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, client devices 202a are any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera.

Through the client devices 202a-n, users (e.g., BPM customers and/or BPM .) 212a-n communicate over the network 206 with each other and with other systems and devices coupled to the network 206. As shown in FIG. 2, server devices 204 and 213 may be also coupled to the network 206.

### Illustrative Examples of Some Embodiments of the Instant Invention

In some embodiments, the long-term execution processes can have a duration that is measured in months or even years, during which changes may occur in the underlying process. In some embodiments, the long-term execution processes represent processes that require process instances for changed processes to coexist with instances that have began executing prior to a process change, and, for changes, to be applied to instances in progress.

In some embodiments, the instant invention allows for minimal, if any, caching of BPM Diagram definition—i.e., re-loading and/or parsing of BPM diagram at execution time with each iteration.

In some embodiments, the instant invention allows to avoid using stacks or other structures to maintain state information from prior cycles to determine next state. In some embodiments, the instant invention allows to determine future state solely from current positions within a BPM Diagram and the BPM Diagram's description.

In some embodiments, the instant invention allows to avoid using message tables for message correlation (e.g., message handling is via instance search as message initiation, with success or failure)—i.e., message correlation can be instantaneous and stateless.

In some embodiments, the instant invention allows to avoid using separate database management or user task management outside of the inventive system because data objects that are not native to the inventive system (e.g., people, tasks) can be represented via process instances with attributes.

In some embodiments, process instances (that also act as data items) can be tied to, and stored in association with, instances that spawned them (so, for example, if the instant invention uses files as storage, spawned instances can be represented as sections within the same .xml file that stores the parent instance, or as files within a sub-directory of the directory for the instance).

In some embodiments, the instant invention allows to link to a BPM Diagram metadata that is associated with a current state of an instance (a BPM case) so that process activities can be performed plus set of process activities yet to be performed. In some embodiments, the instant invention can allow and account for change(s) (delta) in metadata as BPM process's progresses by querying states at time t and at time t+1.

In some embodiments, the instant invention allows to unify all data necessary for execution with all data necessary for display/editing into a single data object (.xml). In some embodiments, the instant invention allows for parsing and/or automated analysis using the diagram topology at run-time which can be used to automatically predict remaining execution time for a long process (for example, estimating how long a customer's application for new electrical service may take to be processed) through aggregation of the remaining steps.

In some embodiments, the instant invention allows for advising human process participants of the other necessary participants and/or approval steps so that they can prioritize (for example, given multiple action choices, a user might choose the one that does not require a lot of approvals or requires approvals from lower level managers).

In some embodiments, the instant invention allows for automating collaboration—i.e., by associating a specialized diagram with a particular data object (e.g., a manager associating a specialized process to a project such that in order to cancel the project, a specific approval process must be followed).

In some embodiments, the instant invention allows for automated GUI generation—e.g., using the BPM Diagram to advise users of what options are available and exposing them via the GUI

In some embodiments, the instant invention allows for automated generation of documentation/help—e.g., programs may use the BPM diagram associated with data to automatically generate documentation describing what steps remain to be taken in order to complete a process.

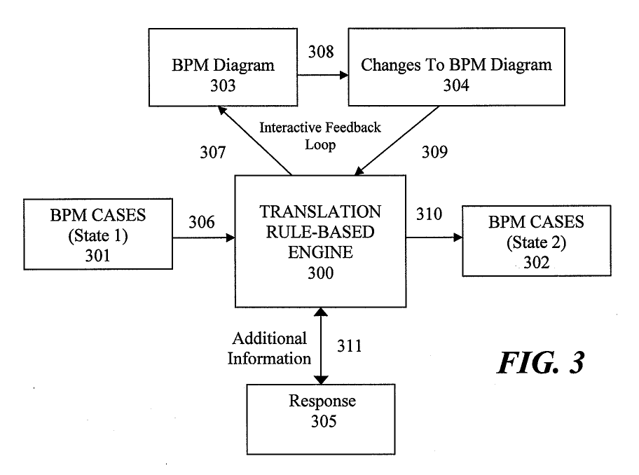

Some embodiments of the instant invention can be designed and operated in accordance with a schematic diagram in FIG. 3. In some embodiments, block 300 represents a translation rule-based engine which translates BPM cases in a first state, block 301, to BPM cases in a second state, block 302 when a change to a BPM diagram occurs. For some embodiments, a BPM case is an instance of a business process proceeding in accordance with a BPM diagram. For example, in the case of an electrical utility, in some embodiments, if a BPM diagram represents a business process of opening a customer account, then each BPM case is a separate process of account opening for a particular customer. In some embodiments, for each BPM case it can be necessary to record all code statements executed for the BPM case since its initialization, as well as what are the current activities it is expected to execute next in response to timeouts or message received events, plus the history of values all state variables as declared in the code and/or executed so far.

In some embodiments, using an interactive feedback loop 307-309, the translation rule-based engine, block 300, incorporates changes into a BPM Diagram, block 303, when the engine, block 300, receives information indicating a change to a BPM Diagram, block 304. In some embodiments, the translation rule-based engine, block 300, can incorporate, within itself, a BPM Diagram, block 303, and/or block 304 that communicates changes to the BPM Diagram. In some embodiments, the translation rule-based engine, block 300, can provide an interactive editing tool to receive changes to BPM Diagram, block 304. In some embodiments, a BPM Diagram, block 303 and/or block 304 reside separately from the translation rule-based engine, block 300.

In some embodiments, since the translation rule-based engine, block 300, incorporates chang(s) to a BPM Diagram, block 3, through an interactive feedback loop 307-309, there is only a single version of BPM Diagram (changed/updated) present at any particular time point. In some embodiments, BPM cases, block 301, are then translated by the translation rule-based engine, block 300, into BPM cases, block 302, to confirm BPM cases to the updated BPM Diagram. In some embodiments, the instant invention can avoid a situation when BPM cases are being executed in accordance with different versions of a BPM diagram.

In some embodiments, if, during the translation process, based on its translation rules, the translation rule-based engine, block 300, requires additional input to implement changes to a BPM Diagram and/or translate BPM cases from the first state into the second state, the translation rule-based engine, block 300, requests and/or receives the required additional information (block 305 and communication channel 311).

In some embodiments, inputs received by the translation rule-based engine, block 300, whether related to changes to a BPM Diagram or additional information, can originate from a user/operator and/or another computer system/electronic device.

In some embodiments, a process of editing a BPM diagram (the interactive feedback loop 307-309) can include a series of individual edits which, together, ultimately comprise the entire modification. In some embodiments, the instant invention can employ the integrated development/design environment (IDE) that can allow users to automate operations with multiple changes to happen at once (for example, a delete of a set of activities). In some embodiments, changes may internally be broken down into a succession of smaller incremental changes. An increment, therefore, is an atomic change to a BPM diagram, atomic in the sense that it cannot be further broken down into a series of even smaller increments).

In some embodiments, the instant invention is restricted to changes that result in less than about 50 percent metadata difference between an instance of BPM Diagram prior to change(s) and an instance of BPM Diagram after change(s) is/are incorporated. In some embodiments, the instant invention is restricted to changes that result in less than about 25 percent metadata difference between an instance of BPM Diagram prior to change(s) and an instance of BPM Diagram after change(s) is/are incorporated. In some embodiments, the instant invention is restricted to changes that result in less than about 10 percent metadata difference between an instance of BPM Diagram prior to change(s) and an instance of BPM Diagram after change(s) is/are incorporated. In some embodiments, the instant invention is restricted to changes that result in less than about 75 percent metadata difference between an instance of BPM Diagram prior to change(s) and an instance of BPM Diagram after change(s) is/are incorporated. In some embodiments, the instant invention is restricted to changes that result in less than about 60 percent metadata difference between an instance of BPM Diagram prior to change(s) and an instance of BPM Diagram after change(s) is/are incorporated. In some embodiments, the instant invention is restricted to changes that result in less than about 5 percent metadata difference between an instance of BPM Diagram prior to change(s) and an instance of BPM Diagram after change(s) is/are incorporated. In some embodiments, the instant invention is not limited in the extent of change(s) as long as extensive change(s) (e.g., changes that involve, for example, 50 percent of metadata of a BPM Diagram) can be broken down in a series of incremental changes.

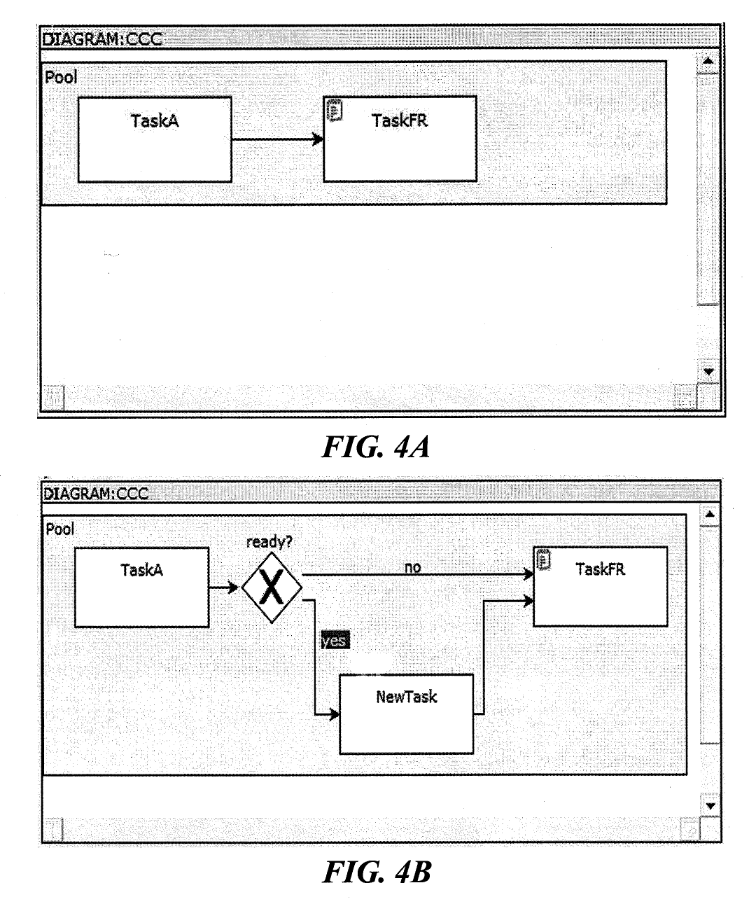

In some embodiments, an example of an incremental change can be when a user wishes to add a small branch to a BPM process that involves executing a set of operations if and only if a condition is satisfied. FIG. 4A shows a BPM Diagram which a user wants to change. FIG. 4B shows a BPM Diagram which results after the user's changes are implemented. In some embodiments, the change from the BPM Diagram of FIG. 4A in to the updated BPM Diagram of FIG. 4B can be expressed as a series of the following incremental operations:

1) Insert data exclusive gateway between activities TaskA and TaskFR, called “ready?”

2) Add a new activity to the diagram called NewTask

3) Add transition path from “ready?” to “NewTask”

4) Set the condition statement associated with the branch from ready? To NewTask to “ready_state==true”

5) Set the condition statement associated with the branch from ready? To TaskFR to “ready_state !=true”; and

6) Add a transition path from NewTask to TaskFR.

In some embodiments, when applying a single incremental change to the existing cases without having access to what other incremental changes remain to be later applied would not necessarily be valid, and such changes would then have to be un-done if, or example, the user later changed his/her mind before submitting the final and complete set of changes. In some embodiments, an actual modification of the cases is not performed until a user indicates that all changes have been given. In some embodiments, it can be the responsibility of the Editing system (the translation rule-base engine, block 300, and/or block 304) to keep track of all the individual changes made as changes are received; such that a difference between a “before” BPM Diagram and a modified “after” BPM Diagram can be expressed as a series of smaller modifications.

In some embodiments, the instant invention allows a user, while editing a BPM Diagram, to make a change and then “undo” the change and/or delete a previously made change. In some embodiments, it can be the responsibility of the Editing system (the translation rule-base engine, block 300, and/or block 304) to process such operations and remove deleted incremental changes from the recorded series of changes.

In some embodiments, the instant invention can provide a functionality that resolves conflicts among changes (e.g., one change may obviate another). For example, in some embodiments, if a user were to specify a condition for a given branch, and then later specify a different condition for the same branch, then the second condition would obviate the first. In some embodiments, a corrective action by the Editor system (the translation rule-base engine, block 300, and/or block 304) can entail discarding the incremental change that was first specified the condition and replace it, such that only one change can remain in the recorded series of changes.

### Examples of Coding BPM Diagrams as Data Types in Some Embodiments

1. Customer Tracking of Progress of Application for Electric Service

For example, an utility can implement an automated system whereby customer's can, via self-help web site, submit application for electric service and track progress on line. A BPM system, in accordance with some embodiments of the instant invention, can track and orchestrate all activities pertaining to approval and installation of electric service, from initial application to initiation of service. The exemplary BPM system can, on request of customer, parse electronic description of BPM Diagram corresponding to customers instance, determine which steps have been completed vs. which remain, apply estimates for completion time to those that have not yet been completed, and provide customer with total completion time estimate.

2. Preview of Work or Steps Required

Similar to above, but, in some embodiments, the exemplary BPM system can provide a customer with text summary of what steps remain to be performed for the process via parsing of diagram and associated documentation for each process step.

3. Coordination of Activities Across Multiple Participating Entities

In one example, an electric utility seeks to install new equipment (power lines) under the street within a city. For example, performing installation requires coordination with city for permits to work in the street, but permits can not be issued until date of electric shutoff can be determined. For example, city agency needs information in order to coordinate resource allocation and get permits approved in time for the outage. For example, BPM process system handling the permit approval at city agency needs information pertaining to progress of construction project instance being tracked by BPM system at utility. For example, BPM system at utility can be capable of providing electronic expression of diagram, along with associated metadata for progress of instance (state) to agency's BPM system so that agency's BPM system can trigger its activity accordingly. In some embodiments, if BPM Diagrams are coded as data type, BPM systems can poll or query for progress when and as needed.

For example, in accordance to some embodiments, BPM systems can poll or query for progress, when a BPM diagram for a customer service application that is invoked when a customer places a status inquiry with respect to a pending project. In some examples, the invoked instance can, in order to determine progress of the customer's project, send a message to the BPM server associated with the customer's project and receive back a BPM Diagram's definition, along with state information for the project instance. In some examples, the customer status application could then call a function to parse the received the BPM Diagram's definition and state information to determine an estimate of remaining time to complete the customer's project.

### Examples of Using File Structure Hierarchy in Some Embodiments

In some embodiments, the instant invention can use a file structure hierarchy method to store data, for example, by the translation rule-based engine, block 300. For example, the translation rule-based engine, block 300, can use the file structure hierarchy method to store and manage data for (1) BPM cases and/or (2) BPM diagram.

For example, as a BPM-driven construction application involving departments, documents, and projects, in accordance with some embodiments, the instant invention can organize records for such application as a high level directory with a sub-directory labeled ‘projects’ and can have a sub-directory for each project, containing and a document describing the project. In another example, there might be an additional directory called “customers” with a sub-directory for each customer by, for example, customer number, and a sub-subdirectory under that called ‘projects’ for each project the customer has contracted to be done. In some embodiments, the resulting file structure of the BPM-driven construction application can looks as follows:

/construction/projects/[project #]/project_description.xml
And
/construction/customers/[customer#]/projects/[project#]/
project_description.xml.

In some embodiments, a BPM Diagram can be associated with a projects pool with one instance per project, and a customer pool with one instance per customer. In some examples, if, in the BPM Diagram, a project is completed, the project instance associated with the project can generate a message to the customer instance indicating that the project had ended. In some embodiments, using the file structure hierarchy, each instance can store its state data in a file system according to an application's naming and storage convention, so the instance's address for the message to be sent could be explicitly stated by generating the following commuter commands, inter alia, in php language: $target_instance_id=“construction/customers/$cust_number/projects/$project_number”.

In some embodiments, the instant invention can use a single unified mechanism for (i) to organize data for business entities, (ii) to persist state data for process instances, and (iii) to correlate inter-instance messages, namely the file structure system itself.

In some embodiments, BPM case's state data is stored in files on a file system with a file path auto-generated as a sub-directory of the directory storing the BPM case that spawned it. In some embodiments, sub-directories are auto-created when first used, and auto-deleted when empty. In some embodiments, spawning activities may specify at run-time a different path, using any combination or program variables and existing path, etc. In some embodiments, instances of BPM cases and BPM Diagram may also change the path where they are stored at run-time via a path relocation operation which can, if necessary, delete the instance data from one location and move it elsewhere. In some embodiments, instances that seek to pass messages to other pre-existing instances (e.g. correlate with them) do so by specifying their path.

a) Utility Tracks Customers' Application for Electric Service

For example, electric utility uses a BPM Diagram to track progress of customer's application for electric service, each of which invokes necessary sub-processes that can happen simultaneously:

1. engineering analysis to determine type of service;

2. city approval for permits to dig at site; and

3. accounting for budget estimate or work to be performed.

For example, each sub-process instance, needs to send correlated message back to initiating instance telling it that sub-process has completed and/or has reached a given milestone.

According to some embodiments of the instant invention, developer designing BPM diagrams determines a data directory structure that, for example, places each customer's information in a directory called “new_acoounts”, followed by a sub-directory named by the customer's account number, followed by a sub-directory named for the department handling a necessary sub-process (e.g, new_account/$account #>/<$department>). For example, the BPM process for application of electric service might be named to be located at: new_accounts/<account #>/application_for_service.

In correlation, for example, any sub-process only needs to insert the correct values into the string “new_accounts/<account #>/application_for_service” in order to send a message to the correct instance.

### Examples of Rules to be Applied by the Translation Rule-Based Engine (Block 300)

In some embodiments, an incremental operation can require additional specification without which no translation can be performed because there is insufficient information. For example, in some embodiments, change #1 above with respect to FIGS. 4A-B states that a data exclusive gateway to be added without having first specified what the condition should be. It is not until change #5 that the requirement of change #1 is satisfied. In some embodiments, the translation rule-based engine (block 300) can maintain a database of requirements as incremental changes are proposed. In some embodiments, as each incremental change is added to the series, some requirements can be added to the database, and, at the same time, some other requirements may be resolved and can be removed.

In some embodiments, the sequence of incremental changes can represented in a form of a database of specifications. In some embodiments, as each incremental change is introduced, the inventive system identifies requirements implied by the change, can check through the existing database of requirements and specifications to see if the requirements are satisfied, and, if not, adds the requirement to the set of unsatisfied requirements. In some embodiments, the inventive system can also check to see if the updated BPM Diagram's specification causes the existing requirements in the database to become satisfied, in which case the satisfied requirements can be removed from the database and/or marked as resolved. In some embodiments, the inventive system provides functionalities to build, track and/or resolve a set of unsatisfied requirements. In some embodiments, rules, for example, can apply not only to how to update BPM cases, but also can define what requirements are needed to be fulfilled in order to update BPM cases, and/or what other changes may satisfy those requirements.

Referring back to an example of FIGS. 4A-B, the following is an illustration of how the translation rule-based engine, block 300, can operate in accordance to some embodiments of the present invention:

1. Insert data exclusive gateway between activities TaskA and TaskFR, called “ready?”

Rules:

A) REQIREMENTS: add requirement A to specify condition for transition from “ready?” To TaskFR;

B) REQIREMENTS: add requirement B to have more than one branch from “ready?”;

C) REQIREMENTS: identify a sub-set of cases (to be labeled Subset 1) of the existing cases as those that have already taken the transition from TaskA to TaskFR;

2. Add a new activity to the diagram called NewTask

Rules:

D) REQIREMENTS: add optional requirement C to have a way to get to activity NewTask;

E) REQIREMENTS: add optional requirement D to specify what code should be executed for activity NewTask;

3. Add transition path from “ready?” to “NewTask”;

Rules:

F) REQIREMENTS: add requirement E to specify condition for transition from “ready?” To NewTask;

G) REQIREMENTS: mark requirement C as satisfied;

H) REQIREMENTS: mark requirement B as satisfied;

I) REQIREMENTS: change requirement D as to mandatory;

J) REQIREMENTS: identify a requirement to determine how to handle cases in subset 1;

4. Set the condition statement associated with the branch from ready? To NewTask to “ready_state==true”

Rules:

K) REQIREMENTS: mark requirement A as satisfied.

L) REQUIREMENTS: add a requirement to determine if the statement “ready_state=true” would have been modified by any code executed by any members of set 1, after taking the transition to set 2.

5. Set the condition statement associated with the branch from “ready?” To TaskFR to “ready_state !=true”

Rules:

M) REQIREMENTS: mark requirement E as satisfied.

N) REQUIREMENTS: identify a set (to be called subset 3) of cases in subset 1 defined as those for which the condition statement associated with the branch from “ready?” To TaskFR would have been true.

6. Add a transition path from NewTask to TaskFR.

### Examples of Interactive Feedback Loop (307-309)

The following are some example rules for modification of BPM diagrams interactively in accordance with some embodiments of the instant invention:

1. RULE: if a condition statement is introduced, it is necessary to determine how to split the set of BPM cases that would have executed the condition statement into sub-sets, one for each branch, and handle them separately. The identification of each sub-set is tied to the ability to identify the parent set, and also tied to the valid evaluation of the branch's conditional statement

2. RULE: a conditional statement may be validly applied (i.e., it may be executed and its results used to identify sub-sets) for any BPM case where there is no dependency between the code executed since the transition associated with the conditional statement and the statement itself, given the state variables of the instance that existed at the time of the transition.

3. RULE: If a new variable is introduced to a diagram (i.e. declared in the code for an activity) then

a) for all cases that have not yet executed that activity will gain a new state variable of the same name, with its value set to the default value,

b) for all cases that have already executed the activity will gain a new state variable of the same name, marked as “value undefined” indicating that the variable didn't even exist at the time the instance was created.

4. RULE: if a call or macro is introduced to a diagram at a given point, then it is necessary to determine, for those cases that have already executed the associated transition, whether the call would have been executed and, if so, should

i) the code be executed after the fact,

ii) some other code be executed, and/or

iii) should values remain unmodified.

### Examples of Long-Term Execution Processes

1. Law Replevin (Electric/Gas Utility)

An energy utility (e.g., Con Edison) has to go through an elaborate process for removing it's equipment (electric meters) from customer sites when customers are delinquent in paying their energy bills. The process, which includes required legal steps such as filing papers with the court, serving of documents, sending of mails, waiting for checks to clear, etc. takes on average 180 days, and can take upwards of a year, depending on how many hearings, ruling etc. are made in each case.

In some embodiments, the long-term BPM system of the instant invention can be used both to model (depict) and manage (implement) the process, with a process instance generated for each customer. In some embodiments, the process instance can be instantiated(launched) when a customer's credit status indicates that they are in default and should be handled legally, and can end when they have either paid in full and are no longer in default, or when the Utility has successfully removed its equipment from the location, via a marshal. In some embodiments, a business entity that manages the BPM process system can be either utility, its law firm, a combination, or an outsourced firm that manages the BPM application.

2. Law Replevin Process, for Other Form of Utility

Similar to the example no. 1, for a different type of utility e.g,:

a) water utility, for its meter, or other equipment;

b) communication utility (TV/Internet/Phone)—for its set-top box and/or router equipment; and

c) Manufacturing Equipment leasing company—for recovery of leased equipment in default.

3. Legal Processes for Recovery of Goods

Similar to the example 2 (c), but for long-term regulated legal process for recovery of goods, equipment or property (e.g., customer can be business entity (e.g. bank) or law firm representing them).

4. Foreclosure of Real Estate

Foreclosure/repossession of automobiles or other leased equipment or property.

5. Process for Application of Service

For example, a customer applies for new electric or gas or water service, with the application process starting when service is requested and ending when service and billing has been established. The application process may, for example, take days, months, or years depending upon complexity of project (e.g. large building or development) and need for regulatory approvals.

6. Process for Loan Application or Credit Application

For example, use of long-term BPM system for a process involving customer's application for credit or loan approval, starting when request is received and ending when loan or credit has been closed (or credit line set up) or rejected.

7. Training Programs for Employees

For example, enterprise (e.g. large utility) with employees requiring training programs and certification in order to become qualified for certain jobs can use the long-term BPM process in accordance with some embodiments of the instant invention to track employee's progress in conduct of training program. Successful completion of specific milestones results in automatic entry of employee into qualification databases, and initiation of sub-processes for follow-on training programs. In some examples, the BPM process can also track loss of qualification (ageing) and need for re-qualification or re-certification.

8. Promotion/Career Tracking

Similar to Example 7 above, but for career management. For example, a process begins when employee starts employment, and ends upon termination or retirement. Process instance tracks key career-related events such as promotions, leave of absences, attainment of new qualifications, eligibility for new positions, raises etc. process automatically flags employees eligible for new programs and sends notices etc.

9. Customer/Supplier Qualification Tracking

Similar to examples 7 and 8, but for customers or suppliers (tracking of long-term value customers) as opposed to employees.

10. Cradle to Grave Orchestration of Infrastructure Life

Similar to Example 8 above, but for management of infrastructure that is designed to last many decades. For example, a process begins when a piece of equipment gets purchased from a vendor (e.g. a distribution transformer) where the asset begins service when it is installed, and ends upon removal and retirement. Process instance tracks key operational and maintenance events such as preventive maintenance (e.g. changing of dielectric fluid), mandated periodic inspections, operations requiring the infrastructure to go through a series of testing (e.g. High potential testing of windings), whether the equipment is in service or out of service for a given amount of time, exceeding threshold levels of service, procedural compliance inspections (e.g. Safety and environment inspections based on age, interrupt, regulatory requirements), anomaly detection outside of design basis (e.g. Ampacity exceedance or Low oil pressure, high temperature). One process infrastructure life instance would manage subprocesses and instances associated with this piece of equipment over the life of the equipment, which could upwards of 50 years. Various processes would automatically flag employees or other decision support systems to orchestrate work on the equipment based on the existing processes (e.g. typically company procedures mandating activities of compliance) that pertain to this type of infrastructure. Upon the amendment or additional process associated with this type of infrastructure, the process automatically flags the infrastructure as eligible for new maintenance or inspection requirements taking into consideration its present state in the process of providing service.

In some embodiments, the instant invention involves a method for executing long-term business process that can includes steps of a) providing, by a computer system, an interface to design or modify at least one BPM diagram for at least one business process; b) providing, by a computer system, at least one data structure, wherein the at least one data structure store at least one of: i) at least one specification parameter of the at least one BPM diagram, ii) at least one first requirement associated with at least one specification parameter of the at least one BPM diagram; and iii) at least one state parameter of at least one BPM instance, wherein each BPM instance represents at least one pending instance of the at least one business process which is being executed in accordance with the at least one BPM diagram; c) receiving, by a computer system, at least one incremental change to the at least one BPM diagram; d) implementing, by a computer system, based on at least one first set of rules, the at least one incremental change into the at least one BPM diagram, wherein the at least one first set of rules is applied to the at least one incremental change based on one of: i) whether the at least one incremental change requires outside information prior to be implemented; and ii) whether the at least one incremental change results in a satisfaction of the at least one requirement; and e) translating the at least one state parameter of the at least one BPM instance from a first condition to a second condition based on: i) the at least one BPM diagram incorporating the implemented at least one incremental change; and ii) at least one second set of rules, wherein applying the at least one second set of rules can result in receiving outside information which is required prior to the translating.

In some embodiments, the instant invention involves a computer system for executing long-term business process that includes a) memory having at least one region for storing computer executable program code; and b) a processor for executing the program code stored in the memory, wherein the program code which includes: i) code to provide an interface to design or modify at least one BPM diagram for at least one business process; ii) code to provide at least one data structure, wherein the at least one data structure store at least one of: 1) at least one specification parameter of the at least one BPM diagram, 2) at least one first requirement associated with at least one specification parameter of the at least one BPM diagram; and 3) at least one state parameter of at least one BPM instance, wherein each BPM instance represents at least one pending instance of the at least one business process which is being executed in accordance with the at least one BPM diagram; iii) code to receive at least one incremental change to the at least one BPM diagram; iv) code to implement, based on at least one first set of rules, the at least one incremental change into the at least one BPM diagram, wherein the at least one first set of rules is applied to the at least one incremental change based on one of: 1) whether the at least one incremental change requires outside information prior to be implemented; and 2) whether the at least one incremental change results in a satisfaction of the at least one requirement; and v) code to translate the at least one state parameter of the at least one BPM instance from a first condition to a second condition based on: 1) the at least one BPM diagram incorporating the implemented at least one incremental change; and 2) at least one second set of rules, wherein applying the at least one second set of rules can result in receiving outside information which is required prior to the translating.

While a number of embodiments of the present invention have been described, it is understood that these embodiments are illustrative only, and not restrictive, and that many modifications may become apparent to those of ordinary skill in the art. For example, certain methods may be “computer implementable” or “computer implemented.” In this regard, it is noted that while such methods can be implemented using a computer; the methods do not necessarily have to be implemented using a computer. Also, to the extent that such methods are implemented using a computer, not every step must necessarily be implemented using a computer. Further, any steps described herein may be carried out in any desired order (and any steps may be added and/or deleted).

What is claimed is:

1. A method for executing long-term business process, comprising:
a) providing, by a computer system, an interface to design or modify at least one BPM diagram for at least one business process;
b) providing, by a computer system, at least one data structure, wherein the at least one data structure store at least one of:
i) at least one specification parameter of the at least one BPM diagram,
ii) at least one first requirement associated with at least one specification parameter of the at least one BPM diagram; and
iii) at least one state parameter of at least one BPM instance, wherein each BPM instance represents at least one pending instance of the at least one business process which is being executed in accordance with the at least one BPM diagram;
c) receiving, by a computer system, at least one incremental change to the at least one BPM diagram;
d) implementing, by a computer system, based on at least one first set of rules, the at least one incremental change into the at least one BPM diagram, wherein the at least one first set of rules is applied to the at least one incremental change based on one of:
i) whether the at least one incremental change requires outside information prior to be implemented; and
ii) whether the at least one incremental change results in a satisfaction of the at least one requirement; and
e) translating the at least one state parameter of the at least one BPM instance from a first condition to a second condition based on:
i) the at least one BPM diagram incorporating the implemented at least one incremental change; and
ii) at least one second set of rules, wherein applying the at least one second set of rules can result in receiving outside information which is required prior to the translating.

2. A computer system for executing long-term business process, comprising:
a) memory having at least one region for storing computer executable program code; and
b) a processor for executing the program code stored in the memory, wherein the program code comprising:
i) code to provide an interface to design or modify at least one BPM diagram for at least one business process;
ii) code to provide at least one data structure, wherein the at least one data structure store at least one of:
1) at least one specification parameter of the at least one BPM diagram,
2) at least one first requirement associated with at least one specification parameter of the at least one BPM diagram; and
3) at least one state parameter of at least one BPM instance, wherein each BPM instance represents at least one pending instance of the at least one business process which is being executed in accordance with the at least one BPM diagram;
iii) code to receive at least one incremental change to the at least one BPM diagram;
iv) code to implement, based on at least one first set of rules, the at least one incremental change into the at least one BPM diagram, wherein the at least one first set of rules is applied to the at least one incremental change based on one of:
1) whether the at least one incremental change requires outside information prior to be implemented; and
2) whether the at least one incremental change results in a satisfaction of the at least one requirement; and
v) code to translate the at least one state parameter of the at least one BPM instance from a first condition to a second condition based on:
1) the at least one BPM diagram incorporating the implemented at least one incremental change; and
2) at least one second set of rules, wherein applying the at least one second set of rules can result in receiving outside information which is required prior to the translating.
